(19) United States
(12) Patent Application Publication
(10) Pub. No.: US 2008/0192681 A1
(43) Pub. Date: Aug. 14, 2008

(54) Multi-Mode User Equipment and Routing Controlling Method Thereby

(76) Inventors: Byung-Bog Lee, Daejeon (KR); Myung-Nam Bae, Daejeon (KR); Kwang-Hyun Ro, Daejeon (KR); Ae-Soon Park, Daejeon (KR)

Correspondence Address: STAAS & HALSEY LLP, SUITE 700, 1201 NEW YORK AVENUE, N.W., WASHINGTON, DC, 20005, US

(21) Appl. No.: 11/915,145

(22) PCT Filed: May 19, 2006
(86) PCT No.: PCT/KR2006/001886

§ 371 Date: Nov. 20, 2007

(30) Foreign Application Priority Data
May 20, 2005 (KR) 10-2005-0042436
Nov. 15, 2005 (KR) 10-2005-0108947

(51) Int. Cl. H04Q 7/00

(52) U.S. Cl. 370/328

(57) ABSTRACT

The present invention provides multi-mode user equipment for supporting wireless data communication with the Internet through various access networks. The multi-mode user equipment includes a plurality of network interfaces for supporting access to the respective access networks. In addition, the multi-mode user equipment collects information on the state of the respective access networks from the respectively corresponding network interfaces, selects a network interface that is capable of providing a stable data communication path based on the collected information, and establishes a data communication path. Further, the multi-mode user equipment releases the data communication path when data packets are not subsequently transmitted/received through the corresponding data communication path to thereby achieve efficient use of resources.

### TECHNICAL FIELD

The present invention relates to multi-mode user equipment and a method for controlling a communication path of multi-mode user equipment. More particularly, the present invention relates to multi-mode user equipment for supporting access to a plurality of networks, and a method for controlling a communication path for enabling data communication through an optimal network.

### BACKGROUND ART

Recently, as user's interest and demand for use of the mobile Internet has increased, wireless data communication that provides bi-directional communication anytime and anywhere using a communication terminal such as a portable terminal, a notebook computer, and a personal digital assistant (PDA) rather than using an existing data communication service served through a wired network has emerged.

As wireless communication networks are being continuously developed, wireless data communication services are provided on the basis of new types of wireless networks, such as a code division multiple access (CDMA) scheme, and a wideband CDMA (WCDMA) that has been developed in an asynchronous manner is also provided for serving the wireless data communication service.

In addition, the existing wireless local area network (WLAN) system such as the IEEE 802.11 standard can be variously applied for establishing a network between buildings, an area where mobility of a terminal is essential, or an area where it is difficult to install cables. The WLAN provides a data communication scheme that allows short-range wireless communication with reference to stationary access points, and thus the WLAN supports wireless data communication as opposed to wired data communication in a local area rather than supporting mobility of a mobile subscriber station (MSS).

A wireless broadband portable Internet service (WiBro) system is being developed at present by combining features of the WLAN that provides a data communication service with high speed and high quality and a mobile communication network having a wide range of service available areas in order to support the mobility of the MSS.

The WiBro, developed by the IEEE 802.16 working group, guarantees mobility at 60 km/h within 1 km using the 2.3 GHz band frequency, and supports a 3 Mbps download speed and a 1 Mbps upload speed for each subscriber. The WiBro system has merits of mobility and high-speed data communication, but it also has drawbacks in that its service coverage is relatively small and a mobile communication system cannot be provided with high-speed service due to limited capacity.

Coverage areas of various communication networks may be overlapped, and therefore it is important to achieve stable data communication in accordance with traffic conditions of the respective networks when a subscriber's terminal is located in the overlapped coverage area. However, according to the prior art, a mobile terminal supporting service that is available only in the respective networks is used and accordingly it has been difficult to provide a data communication service through an optimal network in an area where the mobile terminal is located.

In addition, a handover is performed from a network-centric point of view even though various network services can be supported by one mobile terminal, and therefore there has been a problem of providing optimal network services since traffic conditions of the corresponding network, characteristics of the mobile terminal, and characteristics of data packets that the mobile terminal transmits/receives at a specific point are not taken into account according to the prior art.

The above information disclosed in this Background section is only for enhancement of understanding of the background of the invention and therefore it may contain information that does not form the prior art that is already known in this country to a person of ordinary skill in the art.

### DISCLOSURE

### Technical Problem

It is an advantage of the present invention to provide multi-mode user equipment that is capable of selecting an optimal network in overlapped coverage areas of various networks, and a method for controlling a communication path for the multi-mode equipment.

### TECHNICAL SOLUTION

In one aspect of the present invention, multi-mode user equipment for supporting wireless data communication with the Internet via a plurality of access networks includes an interface unit and a user equipment operating unit. The interface unit includes a plurality of network interfaces for supporting access to the respective access networks. The user equipment operating unit receives information on the state of the respectively corresponding access networks from the plurality of network interfaces, selects an access network that is capable of providing stable data communication from among the plurality of access networks based on the information, and establishes a data communication path. In addition, the multi-mode user equipment and the respective network interfaces are allocated IP addresses, and the user equipment operating unit includes a network module that matches and manages information on the state of the plurality of access networks transmitted from the plurality of network interfaces and information on the IP addresses allocated to the respective network interfaces.

In another aspect of the present invention, there is provided a method for controlling a data communication path for multi-mode user equipment that includes a plurality of network interfaces respectively supporting access to a plurality of access networks and supports wireless data communication with the Internet via the plurality of access networks. In the method, the multi-mode user equipment obtains IP addresses for the plurality of network interfaces and the multi-mode user equipment, and collects information on the state of access networks that are respectively accessible through the plurality of network interfaces.

In addition, the multi-mode user equipment generates an interface state table by matching the collected information and the IP addresses allocated to the plurality of network interfaces, and generates a path information table by selecting a network interface that supports access to an access network providing stable data communication based on the interface state table. The path information table includes information on a destination IP address for data packet transmission, information on an IP address allocated to the network interface selected by the multi-mode user equipment, and information on an identifier of a timer that controls a lifetime of a data communication path established between the destination IP address and the IP address allocated to the selected network interface.

### ADVANTAGEOUS EFFECTS

According to the present invention, an optimal access network for data packet transmission can be selected by multi-mode user equipment and a data transmission path can be controlled without changing upper layers, thereby guaranteeing mobility in an IP-based communication environment.

In addition, the optimal access network for data packet transmission can be selected in accordance with the type of application service provided to a user in overlapped coverage areas of various networks, and accordingly, the IP-based data communication service can be synchronously achieved through a plurality of networks.

Further, the multi-mode user equipment can easily access various access networks using various network interfaces.

### DESCRIPTION OF DRAWINGS

FIG. 1 shows multi-mode user equipment for accessing the Internet through various access networks according to an exemplary embodiment of the present invention.

FIG. 2 shows multi-mode user equipments located in overlapped coverage areas of various access networks according to an exemplary embodiment of the present invention.

FIG. 3 is a block diagram showing the multi-mode user equipment according to the exemplary embodiment of the present invention.

FIG. 4 shows a protocol stack structure of the multi-mode user equipment of FIG. 3.

FIG. 5 is a flowchart showing an initial network access process of the multi-mode user equipment according to an exemplary embodiment of the present invention.

FIG. 6 exemplarily shows an interface state table according to an exemplary embodiment of the present invention.

FIG. 7 exemplarily shows a path information table according to an exemplary embodiment of the present invention.

FIG. 8 is a flowchart showing a data packet transmission process of the multi-mode user equipment according to an exemplary embodiment of the present invention.

FIG. 9 is a flowchart showing a path control process when the multi-mode user equipment receives the data packet through an access network.

### BEST MODE

An exemplary embodiment of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature, and not restrictive. Like reference numerals designate like elements throughout the specification. In addition, throughout the specification and claims that follow, unless explicitly described to the contrary, the word “comprise/include” or variations such as “comprises/includes” or “comprising/including” will be understood to imply the inclusion of stated elements but not the exclusion of any other elements.

In addition, the word “module” means “a block configured to enable modification of a system of a hardware or software, or provide a plug-in function thereto, that is, a unit or block that performs a specific function of hardware or software.

Through the specification and claims, the word “multi-mode user equipment” refers to a communication terminal that is capable of IP-based data communication, and the multi-mode user equipment includes a notebook computer and a personal digital assistant (PDA), and is not restrictive.

Multi-mode user equipment and a method for controlling a communication path of the multi-mode user equipment according to an exemplary embodiment of the present invention will be described with reference to the accompanying drawings.

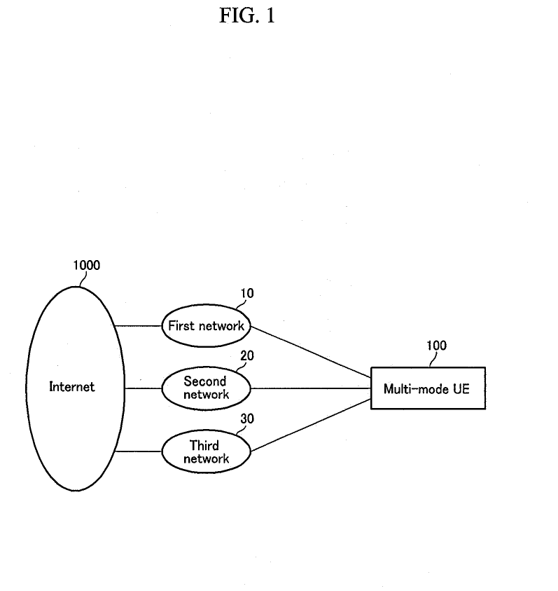

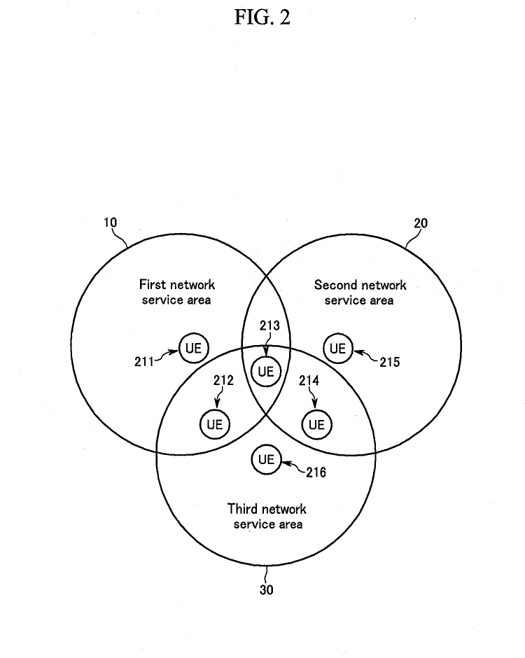

FIG. 1 shows that multi-mode user equipment accesses the Internet through various access networks according to an exemplary embodiment of the present invention, and FIG. 2 shows multi-mode user equipments located in coverage areas of various access networks according to an exemplary embodiment of the present invention.

As shown in FIG. 1, multi-mode user equipment (UE) 100 may access various access networks including a first network 10, a second network 20, and a third network 30, each of which supports the Internet Protocol (IP)-based data communication service. The multi-mode UE 100 accesses the Internet 1000 through the first to third networks 10 to 30. Herein, the first network 10 to the third network 30 may each be one of a wireless personal area network (WPAN), a wireless local area network (WLAN), a general packet radio service network (GPRS), a global system for mobile network (GSM), code division multiple access (CDMA), wireless code division multiple access (WCDMA), and a 3rd generation evolution (3GE) network. Hereinafter, it is assumed that the first network is the WLAN, the second network is the CDMA, and the third network is the 3GE network.

FIG. 2 shows areas where data communication is available through various access networks, that is, overlapped network coverage areas. UEs 212 to 214 become multi-mode UEs that are capable of accessing a plurality of networks when they are located in overlapped coverage areas of different networks, and UEs 211, 215, and 216 become single-mode UEs when they are located in a coverage area of a specific network according to the exemplary embodiment of the present invention.

At this time, the multi-mode UEs 212 to 214 located in the overlapped coverage areas of different networks respectively perform an algorithm for selecting an optimal network for data communication on the basis of the strength of network signals and traffic signals, traffic conditions, and information on network types that can be supported by each UE 212 to 214 in order to achieve the data communication service through a selected network.

In other words, the multi-mode UE 100 supports an interactive interface between the Internet 1000 and the various access networks 10 to 30 in order to allow a subscriber to use an IP packet-based data communication service of the Internet 1000 via the various access networks 10 to 30 by using the multi-mode UE 100 according to the exemplary embodiment of the present invention. In addition, when the network traffic conditions have changed due to movement of the corresponding subscriber or an increase in the number of other subscribers who access the same network, the multi-mode UE 100 may perform data transmission path routing to guarantee optimal wireless communication quality.

Unlike a conventional network-based path control algorithm, a path control algorithm according to the embodiment of the present invention is based on the multi-mode UE 100. The multi-mode UE 100 continuously checks a communication environment of an accessible network and controls a data packet transmission path, and thereby consistently and appropriately responds to variations of the communication environment. In addition, a plurality of data transmission paths via the access networks 10 to 30 can be established to be appropriate for data packets that are respectively generated in accordance with types of application programs executed in the multi-mode UE 100.

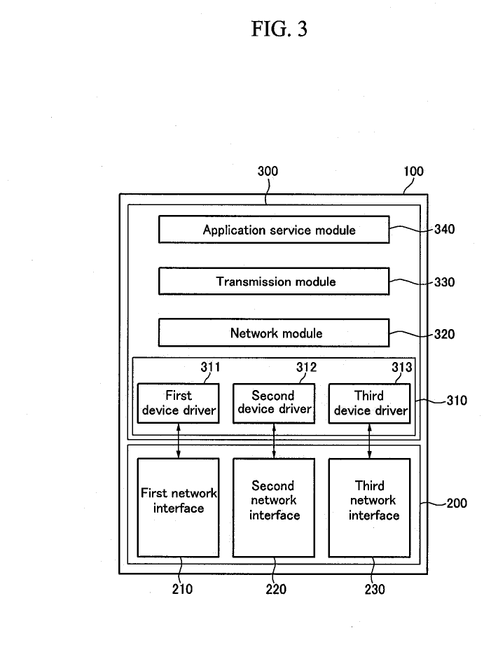

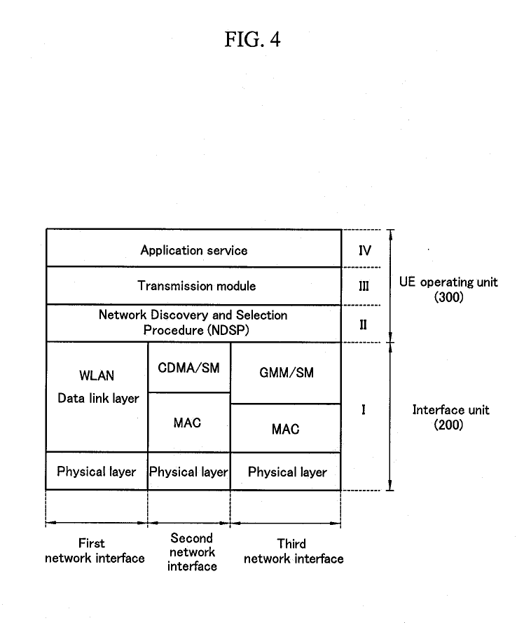

FIG. 3 is a block diagram of multi-mode UE according to an exemplary embodiment of the present invention, and FIG. 4 shows a structure of a protocol stack of multi-mode UE having the same configuration as shown in FIG. 3 according to the embodiment of the present invention.

As shown in FIG. 3, the multi-mode UE 100 includes an interface unit 200 and a UE operating unit 300. The interface unit 200 includes a plurality of network interfaces 210 to 230 for supporting access to the access networks 10 to 30, respectively. In addition, the UE operating unit 300 includes an access module 310, a network module 320, a transmission module 330, and an application service module 340. With such a configuration, the multi-mode UE 100 may have the protocol stack of FIG. 4.

The UE operating unit 300 reads a packet's address by analyzing a header of the data packet, determines an appropriate path, and controls data packet flow and transmission of data packets generated from an application program, and the interface unit 200 transmits/receives the data packets through physical access to the plurality of access networks 10 to 30.

The interface unit 200 realizes functions of a data link layer and a physical layer, and the UE operating unit 300 realizes functions of upper layers of the data link layer, i.e., a network layer, a transport layer, and an application layer. Some of the functions realized in the upper layers may be shared by the interface unit 200 and the UE operating unit 300 depending on characteristics of the network interfaces 210 to 230.

The interface unit 200 includes a plurality of network interfaces 210 to 230 respectively supporting the plurality of access networks 10 to 30 so as to allow the multi-mode UE 100 to function as a UE that is appropriate for the corresponding Internet. As described, the plurality of network interfaces 210 to 230 of the interface unit 200 are configured to realize the functions of the data link layer and the physical layer.

For example, the first network interface 210 may be configured to realize functions of the physical layer and the data link layer that support access to a wireless local area network (WLAN). The second network interface 220 may be configured to realize functions of the data link layer and the physical layer that support access to a code division multiplexing access (CDMA)-based mobile communication network. In addition, the third network interface 230 may be configured to realize functions of the data link layer and the physical layer that support access to a 3GE network and session and bearer establishment.

The third network interface 230 is configured to include a radio resource control (RRC) layer, a radio link control (RLC) layer, a logical link control (LLC) layer, and a media access control (MAC) layer, and realizes mobility management, session establishment, and bearer establishment by signaling between a serving GPRS support network and a gate GPRS supporting node in the 3GE network. In addition, the plurality of network interfaces 210 to 230 are respectively assigned IP addresses for operation.

A hardware module type of network interface, such as a universal serial bus (USB), an IEEE 1394, and PCMCIA, etc., can be used as a network interface for the multi-mode UE 100, or the network interface can be provided in a software module having the above-stated protocol stack and installed to the multi-mode UE 100 according to the embodiment of the present invention.

As shown in FIG. 3, the UE operating unit 300 includes the access module 310, the network module 320, the transmission module 330, and the application service module 340. In addition, the UE operating unit 300 supports an operating system of the multi-mode UE 100 to establish a user-desired data communication service.

The access module 310 includes a plurality of device drivers 311 to 313 respectively corresponding to the plurality of network interfaces 210 to 230 in the interface unit 200 for controlling the interface unit 200 and supporting the operating system of the multi-mode UE 100. As a constituent element for connecting the multi-mode UE 100 and the respective network interfaces 210 to 230, the access module 310 controls hardware constituent elements to appropriately perform expected functions for the corresponding operating system.

That is, the access module 310 controls the respective network interfaces 210 to 230 to establish data communication, and controls the multi-mode UE 100 to function as a UE that is appropriate for characteristics of the corresponding network when the data communication is established through a network interface selected by the multi-mode UE 100.

The network module 320 supports an Internet protocol, and includes a network selection algorithm for selecting a network that can provide optimal wireless data communication quality from among a plurality of access networks than can be supported by the multi-mode UE 100. In addition, the network module 320 collects and manages information on the state of the plurality of access networks, and controls establishment and release of the data communication path through the access network that has been selected on the basis of the information.

The network module 320 controls a data packet transmission path between the multi-mode UE 100, the access networks 10 to 30, and the Internet 1000 within the overlapped coverage area of the plurality of access networks by repeatedly performing the network selection algorithm. In addition, the network module 320 intercepts externally transmitted data packets and externally received data packets, and analyzes IP packet headers of the intercepted packets.

The network module 320 periodically checks variations of the received electric field strength in the respective access networks 10 to 30 by exchanging signals with the respective interfaces 210 to 230 of the interface unit 200, and generates an interface state table 600 for recording information on communication states of the respective access networks 10 to 30. In addition, the interface state table 600 is updated in accordance with variations of the communication state.

The network module 320 selects a network interface, that is, an access network, from among the network interfaces 210 to 230 for providing optimal communication quality on the basis of information recorded in the interface state table 600. In addition, the network module 320 manages information on IP addresses allocated to the network interfaces 210 to 230 for supporting physical access to the access network selected as a result of the network selection algorithm process and information on time set for data transmission through the corresponding path as a form of a path information table 700.

The network selection algorithm used by the multi-mode UE 100 in the embodiment of the present invention is well known, and accordingly, an appropriate network selection algorithm may be selected for the corresponding communication algorithm by those skilled in the art. The network selection and data transmission path control will now be described in more detail.

The transmission module 330 supports a transmission control protocol and a user datagram protocol, and defines data transmission, error correction, and flow control for establishing reliable data communication.

The application service module 340 supports an application program designed to perform a specific service. The application program may include an IP-based packet service application program that is designed to perform web browsing, file transmission, and a streaming service client role. For example, the application service module 340 may include an MP3 codec, an H.263 codec, a web browser, a media player, and an image communication program, etc. The application service module 340 generates a data packet according to a user's application program and transmits the data packet to the Internet 1000.

With such a configuration, the plurality of network interfaces 210 to 230 in the UE operating unit 300 and the interface unit 200 of the multi-mode UE 100 may be respectively assigned an IP address for operation according to the embodiment of the present invention. Allocation of the IP addresses is consistent with an IP allocation method that is appropriate for an operating system environment selected by the multi-mode UE 100. In addition, the multi-mode UE 100 sets one of the IP addresses as a default IP address and uses the default IP address as an identifier of the multi-mode UE 100 in the plurality of access networks 10 to 30.

FIG. 4 shows internal configuration of the multi-mode UE 100 of FIG. 3 corresponding to a protocol stack structure. As shown in FIG. 4, the multi-mode UE 100 can be broadly divided into the interface unit 200 for a protocol stack structure I formed with the physical layer and the data link layer and protocol stacks II to IV for layers above the data link layer.

The plurality of network interfaces 210 to 230 of the interface unit 200 include a physical layer that allows the multi-mode UE 100 to physically access the corresponding network or maintains the physical access between the multi-mode UE 100, and defines electrical, mechanical, procedural, and functional specifications and a data link layer for providing reliable data transmission through the physical access. The network interfaces 210 to 230 including such a protocol stack structure may be configured to have various detailed layers in accordance with types of accessible networks.

For example, the first network interface 210 for supporting access to the WLAN may include the physical layer and the data link layer. In addition, the third network interface 230 for supporting access to the 3GE network may have a protocol stack structure in addition to the physical layer and the data link layer. The protocol stack structure includes a protocol, e.g., a GPRS Mobility Management and Session Management (GMM/SM) protocol partially sharing functions of a network layer performing a function for establishing a session and bearer.

As described, configuration of the multi-mode UE 100 can be varied as long as the network work interfaces 210 to 230 support protocols of the physical layer and the data link layer, the UE operation unit 300 supports protocols of layers higher than the physical and data link layers, and the network interfaces 210 to 230 partially share the functions of the upper layers. A protocol stack and a user application program of the UE operating unit 300 which is interactively operated with the interface unit 200 are determined in accordance with such a configuration of the protocol stack of the network interfaces 210 to 230.

A method for selecting a network and controlling a path performed by the multi-mode UE 100 according to an exemplary embodiment of the present invention will now be described.

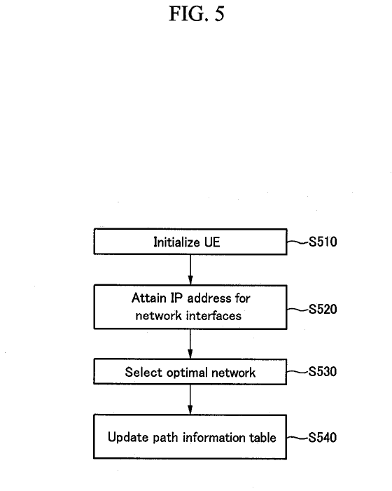

FIG. 5 is a flowchart showing an initial access process of the multi-mode user equipment according to the exemplary embodiment of the present invention. After establishing network access and performing initialization, the network module 320 establishes a data packet transmitting/receiving path before other application programs are executed. FIG. 5 shows a preparation process for establishing such a data packet path.

When the multi-mode UE 100 is supplied with power, the multi-mode UE 100 starts receiving a transmission signal with the network where the multi-mode UE 100 is located after an operating system of the multi-mode UE 100 is initialized, an initial network environment is set, and communication protocol parameters are initialized, in step S510.

The multi-mode UE 100 is assigned an IP address for the respective network interfaces 210 to 230 in the interface unit 200 in step S520. In addition, the multi-mode UE 100 may be assigned an additional IP address for the UE operating unit 300.

At this time, a subscriber may obtain a static IP address for the multi-mode UE 100, and the user may also obtain an IP address through a dynamic host configuration protocol (DHCP) provided by a WLAN access point during initialization of the WLAN in the case that the network interfaces 210 to 230 support access to the WLAN network. In addition, in the case that the network interfaces 210 to 230 support access to the CDMA or 3GE network, the subscriber may obtain an IP address through a signaling process for session and bearer establishment.

The multi-mode UE 100 may set the static IP address among the plurality of IP allocated addresses as a default IP address, or set an initially allocated IP address among IP addresses allocated to the network interfaces 210 to 230 as the default IP address. The default IP address is used as an identifier of the corresponding multi-mode UE for data communication. At this time, the multi-mode UE 100 stores information on the state of the respective access networks transmitted from the interface unit 200 and the plurality of IP addresses in the form of the interface state table 600 and the path information table 700.

The network module of the multi-mode UE 100 performs the network selection algorithm on the basis of the information stored in the interface state table 600 and selects a network for optimal data communication in step S530. Service lifetime and service price of the multi-mode UE 100 may be used as reference parameters when performing the network selection algorithm for selecting the optimal network.

In terms of data transmission power for a mobile UE that typically uses a battery as a power source, a power consumption amount can be varied depending on an overhead of a link layer protocol. Therefore, the multi-mode UE 100 can select a network that is capable of minimizing battery power consumption among currently accessible networks. In addition, a rate system for transmitting/receiving one packet may differ in accordance with types of the access networks 10 to 30, and a user of the multi-mode UE 100 prefers to use a network with an inexpensive rate system, and therefore the service price becomes an important parameter.

In addition, after a network is selected on the basis of the above-stated parameters, consistent quality of service (QoS) should be guaranteed between different access networks when the type of access network through which data communication is performed between the multi-mode UE 100 and the Internet 1000 is changed. Therefore, the network module 100 modifies various protocol parameters including communication speed and QoS management policy for the selected network.

When the network selection algorithm is performed and a network for providing an optimal data communication service is selected at a present location of the multi-mode UE 100, the path information table 700 is updated in step S540.

Steps S520 and S540 of FIG. 5 can be repeated when necessary for establishing a new communication path due to variations of a communication environment of the multi-mode UE 100.

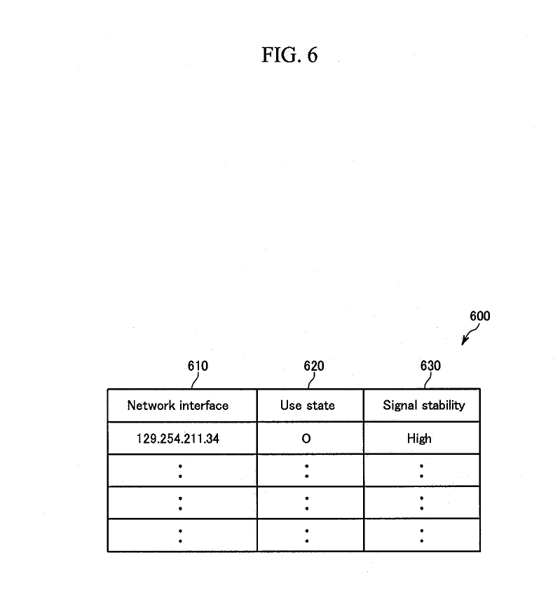

FIG. 6 exemplarily shows an interface state table according to an exemplary embodiment of the present invention. The interface state table 600 used for the network selection algorithm included in the network module 320 includes a network interface field 610, a use state field 620, and a signal stability field 630 as shown in FIG. 6.

The network interface field 610 records and manages IP addresses allocated to the network interfaces 210 to 230 in the multi-mode UE 100. IP addresses allocated to the respective network interfaces 210 to 230 during the initialization stage of the multi-mode UE 100 are recorded. In addition, the network interfaces 210 to 230 may obtain new IP addresses when the multi-mode UE 100 moves and re-enters the previous access network, and the network interface field 610 may be updated. During the initialization stage of the multi-mode UE 100, each network interface field 610 has a null value.

The use state field 620 records and manages the possibility of use of the plurality of interface networks 210 to 230 in the multi-mode UE 100. That is, when the plurality of network interfaces 210 to 230 are activated and allocated IP addresses such that they are in the state of being able to provide a data communication service, the use state field 620 is recoded with a value indicating that the plurality of interface networks 210 to 230 can be used. In addition, when the multi-mode UE 100 moves out of a coverage area of a single network, when the multi-mode UE 100 enters the coverage area but a network card for accessing the corresponding network is not provided to the multi-mode UE 100, or when a deactivated network card is provided to the multi-mode UE 100, the use state field 620 is recorded with a value indicating that the plurality of interface networks 210 to 230 cannot be used and functions to inform that data communication cannot be achieved through the corresponding access network.

In addition, a user of the multi-mode UE 100 may directly determine whether to activate or deactivate the network interfaces 210 to 230 through a setting of the multi-mode UE 100. A value of the use state field 620 is set to be null when the network interfaces 210 to 230 are in the deactivation state. Network interface selection of the network module 320 for the network selection algorithm is limited to network interfaces that are in a usable state in the use state field 620.

The signal stability field 630 measures the strength of signaling signals and traffic signals between the network interfaces 210 to 230 and the corresponding access networks 10 to 30, which have been collected from the interface unit 200 by the multi-mode UE 100, and records and manages a signal stability level obtained by quantifying the measured strength. The network module 320 stores a signal stability level for a network interface in the usable state on the basis of the information recorded in the use state field 620.

At this time, the network module 320 measures the strength of the signaling signals when the multi-mode UE 100 receives a “hello” message periodically broadcasted from the corresponding access network or receives a response to a “probe” message that has been transmitted to the access network from the multi-mode UE 100.

In addition, the signal stability level is calculated by using the measured strength of the signaling and traffic signals. Information on a threshold value of the signal stability, which has been predetermined in accordance with the type of application program used by the subscriber and characteristics of traffic signals, may be embedded in the network module 320 of the multi-mode UE 100, and thus the multi-mode UE 100 may select an appropriate network for data communication based on the information.

A method for analyzing signal stability used for the multi-mode UE 100 is well-known to those skilled in the art, and the method used for the multi-mode UE 100 according to the exemplary embodiment of the present invention may be selected to be appropriate for an operation system and network conditions.

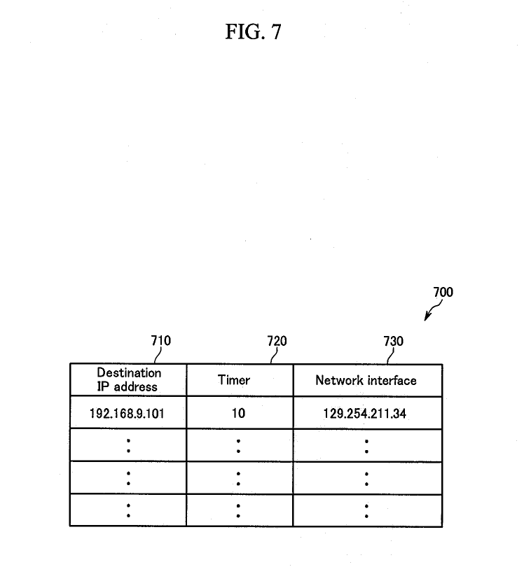

FIG. 7 exemplarily shows a path information table according to an exemplary embodiment of the present invention. The path information table 700 where a result of the network selection algorithm included in the network module 320 is recorded includes a destination IP address field 710, a timer field 720, and a network interface field 730 as shown in FIG. 7. The path information table 700 manages information on a root path for external transmission of data packets when the multi-mode UE 100 transmits data packets generated by executing an application program to the Internet 1000 via the various access networks 10 to 30.

The destination IP address field 710 records and manages a destination IP address to which the generated data packets are expected to be transmitted. The destination IP address may be added or modified by performing the network selection algorithm in the network module 320.

The network interface field 730 records and manages IP addresses allocated to network interfaces for supporting the multi-mode UE 100 to directly access an access network selected as a result of performing the network selection algorithm. The IP address stored in the network interface field 730, that is, the IP address allocated to a specific network interface, may be added or modified by performing the network selection algorithm in the network module 320.

The timer field 720 records and manages a timer identifier that manages time available for communication through a data transmission path, that is, the lifetime of the data transmission path established by using the IP address recorded in the IP address field 710 as a destination and the IP address recorded in the network interface field 730 as a source.

When a network interface is selected from among the plurality of network interfaces 210 to 230 by performing the network selection algorithm, the multi-mode UE 100 generates a timer for setting the lifetime of a data transmission path using the selected network interface, assigns an identifier to the timer, and records the identifier to the timer field 720. At this time, the lifetime set by the timer may vary depending on movement speed of the multi-mode UE 100 and characteristics of the application program generating the data packet.

Similar to the network interface field 730, the timer field 720 is also updated when the network selection algorithm of the network module 320 is performed. In addition, a timer corresponding to the identifier recorded in the timer field 720 is reset when there is a data packet to be transmitted through the data transmission path, and the time is timed-out when there is no data packet subsequently transmitted through the data transmission path within a predetermined time period, and the data transmission path is released. When the timer is timed-out, the corresponding data transmission path is removed from the network transmission table 700.

As described, the lifetime of the corresponding data transmission path is set by using the timer in order to prevent resources of the multi-mode UE 100 from being wasted by maintaining a data transmission path which is no longer used for transmitting a data packet since the multi-mode UE 100 directly selects an access network, and thus a service termination point is not provided.

With such a configuration, the multi-mode UE 100 according to the exemplary embodiment of the present invention enables one multi-mode UE to perform data communication through various data transmission paths in accordance with characteristics of data packets to be transmitted and traffic of an access network to be used.

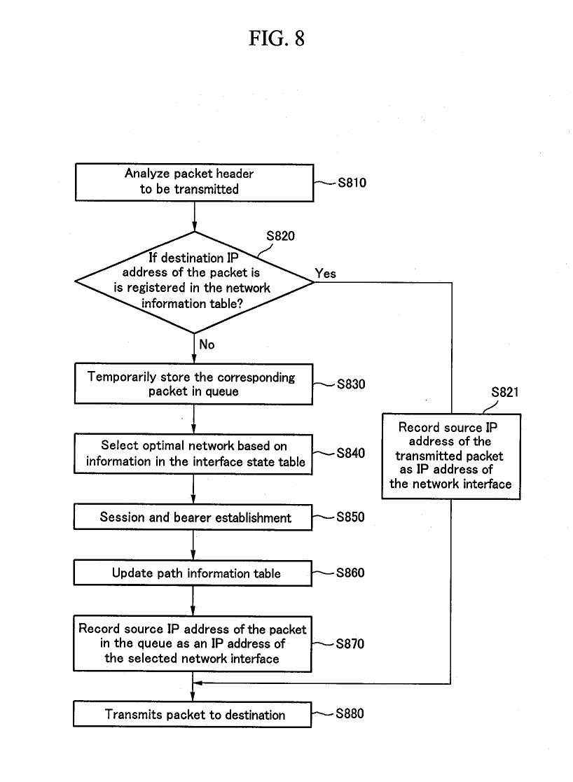

FIG. 8 is a flowchart showing a communication path control process when the multi-mode UE according to an exemplary embodiment of the present invention transmits a data packet.

When a data packet to be transmitted to the Internet 1000 is generated by executing an application program of a subscriber's multi-mode UE 100, upon a service request, the network module 320 intercepts the data packet of the multi-mode UE 100 and analyzes a header of the data packet in step S810. The multi-mode UE 100 extracts a source IP address and a destination IP address of the data packet by analyzing the packet header.

The multi-mode UE 100 determines whether information on a data transmission path using the corresponding destination IP address is recorded in the path information path 700 on the basis of the extracted destination IP address in step S820.

When the destination IP address of the data packet is recorded in the path information table 700, the source IP address of the data packet is changed to an IP address of a network interface recorded in the network interface field 730 of the path information table 700 in step S821. The changed source IP address represents the next path through which the data packet is transmitted, that is, the changed source IP address represents an optimal destined access network.

When the destination IP address of the data packet is not recorded in the path information table 700, the multi-mode UE 100 temporarily stores the corresponding data packet in a queue of the UE operating unit 300 in step S830.

In addition, the multi-mode UE 100 selects the most stable access network with reference to the use state field 620 and the signal stability field 630 of the interface state table 600 in step S840. At this time, the multi-mode UE 100 may select a network interface with the highest signal stability level in the signal stability field 630 from among activated network interfaces, but the multi-mode UE 100 may also select an appropriate access network based on resources and other parameters of the network selection algorithm of the multi-mode UE 100.

The multi-mode UE 100 determines whether the selected network interface supports a protocol that provides the session and bearer establishment function. When the selected network interface supports the protocol, the multi-mode UE 100 interacts with the corresponding access network for the session and bearer establishment using the session and bearer establishment protocol supported by the interface unit 200 in step S850. When the selected network interface does not support the protocol, the multi-mode UE 100 interacts with the corresponding access network for the session and bearer establishment using the session and bearer establishment protocol supported by the UE operating unit 300.

When the session and bearer establishment process performed through the interaction between the interface unit 200 or UE operating unit 300 and the selected access network is terminated, an IP address allocated to the corresponding network interface and the destination IP address extracted from the data packet are correspondingly recorded in the path information table 700 such that the path information table 700 is updated in step S860. At this time, the multi-mode UE 100 generates a timer for controlling lifetime of the corresponding data transmission path, assigns an identifier to the timer, and records the identifier to the timer field 720 of the path information table 700.

When an optimal data transmission path for the data communication service is established through the above-stated process, the data packet temporarily stored in the queue is pulled out and a source IP address of the data packet is changed to the IP address allocated to the selected network interface in step S870. The IP address allocated to the selected network interface indicates an access network destination of the data packet, and therefore the multi-mode UE 100 according to the exemplary embodiment of the present invention may perform data communication via an optimal network access by managing the path information table 700.

The multi-mode UE 100 transmits the data packet, of which the IP address has been changed, to a destination of the Internet 1000 through the selected access network in step S880. At this time, a timer corresponding to the identifier recorded in the path information table 700 is reset when the data packet is transmitted, and the timer is timed-out when there is no data packet subsequently transmitted through the data transmission path within a predetermined time period. In addition, the data transmission path is released and removed from the path information table 700, and the service session and bearer are released.

Through such a process, resources and power of the multi-mode UE 100 can be efficiently used by blocking signaling with the corresponding transmission path when data transmission to a specific destination IP address is stopped due to termination of the corresponding application program.

In addition, when the multi-mode 100 is located in overlapped coverage areas of different networks and a data transmission path selected by the network selection algorithm of the network module 320 is recorded in the path information table 700, packet transmission is available through various paths at a specific point until before data packet transmission is stopped and the timer is timed-out. Therefore, the subscriber of the multi-mode UE 100 may use various application programs with optimal service quality.

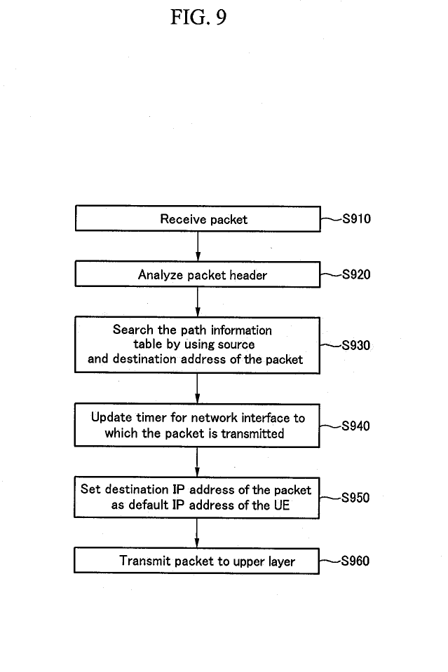

FIG. 9 is a flowchart showing a path control process when the multi-mode UE according to the exemplary embodiment of the present invention receives a data packet through an access network.

When a data packet is externally received at the multi-mode UE 100 through one network interface, the network module 320 of the multi-mode UE 100 analyzes a header of the data packet and extracts a destination IP address and a source IP address in steps S910 and S920.

The multi-mode UE 100 searches the path information table 700 in the network module 320 based on the extracted destination and source IP addresses in step S930. That is, multi-mode UE 100 determines whether the network interface field 730 and the destination IP address field 710 have corresponding information by searching the network interface field 730 by using the destination IP address of the packet and searching the destination IP address field 710 of the path information table 700.

When a transmission path for transmitting the received data packet is recorded in the path information table 700, a timer assigned to the path is reset and updated in step S940.

The multi-mode UE 100 changes the destination IP address of the received data packet to a default IP address of the multi-mode UE 100, that is, an IP address allocated to the UE operating unit 300, in step S950.

In addition, the multi-mode UE 100 transmits the data packet having the changed header information to an upper entity that supports a transmission protocol in order to allow provision of a user-desired data communication service in step S960. At this time, the multi-mode UE 100 sets the corresponding timer that controls the lifetime of the corresponding path to time-out, releases the session and bearer, and removes the corresponding field from the path information table 700 when the multi-mode UE 100 perceives that no more data packets are externally transmitted when there are no data packets subsequently transmitted within the predetermined time period.

The timer controlling the lifetime of the data transmission path established by the network selection algorithm is reset when there is a data packet to be transmitted according to the exemplary embodiment of the present invention. However, the setting of the timer may be canceled and a new timer may be generated, and thus an identifier of the new timer is recorded in the path information table 700 for controlling the data transmission path.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. Multi-mode user equipment for supporting wireless data communication with the Internet via a plurality of access networks, the multi-mode user equipment comprising:
an interface unit comprising a plurality of network interfaces for supporting access to the respective access networks; and
a user equipment operating unit for receiving information on the state of the respectively corresponding access networks from the plurality of network interfaces, selecting an access network that is capable of providing stable data communication from among the plurality of access networks based on the information, and establishing a data communication path.

2. The multi-mode user equipment of claim 1, wherein the user equipment operating unit selects a network interface based on the strength of signaling signals and traffic signals between the multi-mode user equipment and the selected access network.

3. The multi-mode user equipment of claim 2, wherein the plurality of network interfaces are respectively allocated with IP addresses from the Internet.

4. The multi-mode user equipment of claim 3, wherein the user equipment operating unit is further allocated with an IP address.

5. The multi-mode user equipment of claim 4, wherein one of the allocated IP addresses is set to be a default IP address.

6. The multi-mode user equipment of I claim 4, wherein the user equipment operating unit includes a network module for matching and managing information on the state of the plurality of access networks transmitted from the plurality of network interfaces and information on IP addresses allocated to the respective network interfaces.

7. The multi-mode user equipment of claim 6, wherein the network module supports an Internet protocol.

8. The multi-mode user equipment of claim 6, wherein the network module analyzes headers of all transmitting/receiving data packets.

9. The multi-mode user equipment of claim 8, wherein the network module matches information on a data communication path established between the selected network interface and the Internet, generates a timer for controlling lifetime of the data communication path, and manages a path information table generated by matching the timer and the corresponding identifier.

10. The multi-mode user equipment of claim 9, wherein the network module determines whether a communication path for the corresponding data packet transmission is established by searching the path information table based on a destination IP address extracted as a result of analyzing the data packet header.

11. The multi-mode user equipment of claim 9, wherein the network module resets the corresponding timer that matches an identifier stored in the path information table when a data packet is transmitted through a data communication path registered in the path information table.

12. The multi-mode user equipment of claim 9, wherein the network module removes the corresponding data communication path from the path information table when a data packet is not transmitted through the data communication path registered in the path information table within a time period predetermined by the timer.

13. The multi-mode user equipment of claim 2, wherein the plurality of network interfaces support a physical layer protocol for supporting physical access to the plurality of access networks and a data link layer protocol for supporting data transmission through the physical access.

14. The multi-mode user equipment of claim 13, wherein the network interface supports a protocol establishing session and bearer by exchanging signals with an access network that supports physical access.

15. A method for controlling a data communication path of multi-mode user equipment that includes a plurality of network interfaces for respectively supporting access to a plurality of access networks and that supports wireless data communication with the Internet via the plurality of access networks, the method comprising:
obtaining IP addresses for the plurality of network interfaces and the multi-mode user equipment, respectively;
collecting information on the state of access networks respectively accessible through the plurality of network interfaces;
generating an interface state table by matching the collected state information and the IP addresses allocated to the plurality of network interfaces, respectively; and
generating a path information table by selecting a network interface that supports access to an access network for providing stable data communication based on the interface state table.

16. The method of claim 15, wherein the access network state information comprises the strength of signaling signals and traffic signals.

17. The method of claim 16, wherein the path information table comprises information on a destination IP address for data packet transmission, information on an IP address allocated to the network interface selected by the multi-mode user equipment, and information on an identifier of a timer that controls a lifetime of a data communication path established between the destination IP address and the IP address allocated to the selected network interface.

18. The method of claim 17, further comprising:
extracting a destination IP address by analyzing a header of a data packet to be transmitted;
searching the path information table based on the extracted destination IP address; and
modifying header information of the data packet and transmitting the data packet through a data communication path registered in the path information table when the destination IP address is registered in the path information table.

19. The method of claim 18, wherein when transmitting the data packet, header information of the data packet is modified by changing a source IP address of the data packet to an IP address of the network interface registered in the path information table.

20. The method of claim 18, wherein, when the destination IP addresses is not registered in the path information table, the method further comprises:
storing the data packet in a queue;
selecting a network interface to which the data packet is to be transmitted on the basis of the interface state table formation;
establishing a session and bearer by exchanging signals with an access network supported by the selected network interface to generate a communication path;
generating a timer for controlling the lifetime of the communication path, assigning an identifier to the timer, and updating the path information table by using the identifier information, the selected network interface information, and the destination information; and
transmitting the data packet through the communication path by changing the source IP address in the header of the data packet stored in the queue to the IP address of the selected network interface.

21. The method of claim 20, wherein, after the data packet is transmitted, the method further comprises:
determining whether a subsequent data packet is transmitted to the selected network interface within a time period predetermined by the timer: and
maintaining the communication path by resetting the timer when the subsequent data packet is transmitted.

22. The method of claim 21, further comprising terminating the timer and session for the communication path and removing information on the communication path from the path information table when the subsequent data packet is not transmitted within the predetermined time period.

23. The method of claim 20, wherein the generation of the communication path comprises:
determining whether the selected network interface supports session and bearer establishment; and
generating a communication path by establishing a session and bearer by exchanging signals between the selected network interface and the access network when the session establishment is supported.

24. The method of claim 16, further comprising setting one of the obtained IP addresses as a default IP address.

25. The method of claim 24, further comprising:
extracting a source IP address and a destination IP address by analyzing a header of a received data packet;
determining whether the corresponding communication path for transmitting the data packet is established by searching the path information table based on the extracted IP addresses;
resetting a timer set for the communication path when the communication path is registered in the path information table; and
modifying the header information of the received data packet and transmitting the data packet to an application program of the multi-mode user equipment.

26. The method of claim 25, wherein the header information is modified by changing the destination IP address of the data packet to an IP address of the multi-mode user equipment.

27. The method of claim 25, further comprising, after resetting the timer, terminating the timer and removing information on the communication path from the path information table when a subsequent data packet is not received within a time period predetermined by the timer.
